(19) United States
(12) Patent Application Publication
(10) Pub. No.: US 2026/0093800 A1
(43) Pub. Date: Apr. 2, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: KENTARO TAKAHASHI, Tokyo (JP)

(21) Appl. No.: 19/338,387

(22) Filed: Sep. 24, 2025

(30) Foreign Application Priority Data
Sep. 30, 2024 (JP) 2024-170040

(51) Int. Cl. G06F 21/46

(52) U.S. Cl. CPC G06F 21/46

(57) ABSTRACT

According to an aspect of the present disclosure, an information processing apparatus including an authenticating function using authentication information, includes a display that displays the authentication information that is currently set.

### BACKGROUND

### Field of the Technology

The present disclosure relates to an information processing apparatus, a control method, and a storage medium.

### Description of the Related Art

Administrator privileges for an information processing apparatus are granted by authentication of a user as an administrator. The authentication is generally performed by entry of authentication information including a user name and a password.

This authentication information is set to a default value at the time of shipment of the information processing apparatus, and such a default value is often described in manuals or the like and thus known.

If the authentication information remains in its default state, this presents a security risk, so that it is recommended that the authentication information be reset and used. However, users often forget the authentication information after resetting it.

A method for setting a hint to help recall the authentication information when it is forgotten is discussed in Japanese Patent No. 3122549.

In the above-described techniques, it is necessary to perform an operation to display the set hint, and users who are unfamiliar with the operation may be unable to display the hint. For such inexperienced users, it is conceivable to constantly display default authentication information on an apparatus to enable the user to enter the authentication information without referring to a manual.

Even if the authentication information is reset, the default original authentication information continues to be displayed, which may cause confusion for the user.

Thus, it is necessary to appropriately display the hint for the authentication information or the authentication information itself depending on a method of managing authentication desired by the user.

### SUMMARY

According to an aspect of the present disclosure, an information processing apparatus including an authenticating function using authentication information includes a display, at least one memory storing a program, and at least one processor executing the program to display, on the display, the authentication information that is currently set.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an example of a hardware configuration of an information processing apparatus.

FIG. 2 is a schematic diagram illustrating a software configuration implemented on the information processing apparatus.

FIG. 3 is a schematic diagram illustrating a functional configuration of the information processing apparatus.

FIG. 4 illustrates an example of a setting screen displayed by the information processing apparatus according to a first embodiment.

FIG. 5 illustrates an example of an authentication screen displayed by the information processing apparatus according to the first embodiment.

FIG. 6 illustrates an example of an authentication information setting screen displayed by the information processing apparatus according to the first embodiment.

FIG. 7 illustrates an example of an authentication information setting screen displayed by the information processing apparatus according to a sixth embodiment.

FIG. 8A illustrates an example of authentication information stored by the information processing apparatus according to the first embodiment. FIG. 8B illustrates an example of authentication information stored by the information processing apparatus according to a sixth embodiment.

FIG. 9 is a flowchart illustrating a process in which the information processing apparatus according to a second embodiment displays an authentication screen.

FIG. 10 is a flowchart illustrating a process in which the information processing apparatus according to a fifth embodiment displays an authentication screen.

FIG. 11 is a flowchart illustrating a process in which the information processing apparatus according to a sixth embodiment displays an authentication screen.

FIG. 12 is a flowchart illustrating a process in which the information processing apparatus according to a seventh embodiment displays an authentication screen.

FIG. 13 is a flowchart illustrating a process in which the information processing apparatus according to the second embodiment checks whether an authentication setting is a default authentication setting.

FIG. 14 is a flowchart illustrating a process in which the information processing apparatus according to a third embodiment checks whether an authentication setting is a default authentication setting.

FIG. 15 is a flowchart illustrating a process in which the information processing apparatus according to the fourth embodiment checks whether an authentication setting is a default authentication setting.

FIGS. 16A, 16B, and 16C are flowcharts illustrating processes in which the information processing apparatus updates the authentication information, according to the first, second, fourth embodiments, respectively.

FIG. 17 illustrates an example of a screen displayed by the information processing apparatus according to an eighth embodiment when the information processing apparatus receives an instruction to update authentication information.

FIG. 18 is a flowchart illustrating a process in which the information processing apparatus according to the first embodiment displays an authentication screen.

FIG. 19 is a flowchart illustrating a process in which the information processing apparatus according to a ninth embodiment reflects the updating and entry of the authentication information in a screen.

### DESCRIPTION OF THE EMBODIMENTS

Embodiments for implementing the present disclosure will be described below with reference to the accompanying drawings.

### First Embodiment

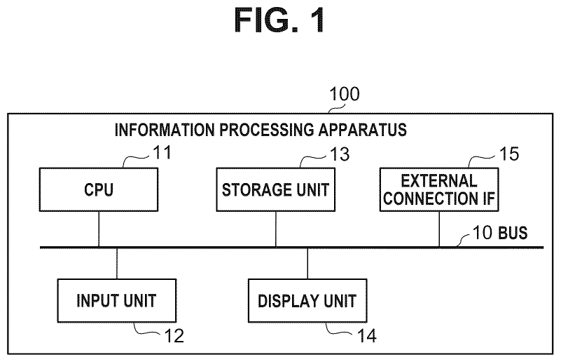

A hardware configuration and a system configuration according to the present disclosure will now be described. FIG. 1 is a diagram illustrating an example of a hardware configuration of a general information processing apparatus 100. As illustrated in FIG. 1, the information processing apparatus 100 includes a central processing unit (CPU) 11.

Each function and flowchart described below is implemented by the CPU 11 executing processing based on programs corresponding to respective applications, program execution environments, and the like, which are stored in a storage unit 13.

An input unit 12, the storage unit 13, a display unit 14, and an external connection interface (IF) 15 are connected to the CPU 11 via a bus 10. The input unit 12 is a keyboard and/or a mouse with which information is input.

The storage unit 13 includes, for example, a read-only memory (ROM), a random-access memory (RAM), and a hard disk device, and stores, in addition to the programs described above, data and the like to be used in processing based on the corresponding programs. The display unit 14 is a display that displays a screen and the like. The external connection IF 15 serves as a network interface and various types of connection interfaces with external apparatuses.

The CPU 11 executes a program and can thereby function as various types of units. A control circuit such as an application-specific integrated circuit (ASIC) that operates in coordination with the CPU 11 may function as these units. Coordination between the CPU 11 and a control circuit that controls the operation of the information processing apparatus 100 may implement these units.

The CPU 11 is not necessarily a single unit, and may be implemented by a plurality of CPUs. In this case, the plurality of CPUs 11 execute distributed processing. The plurality of CPUs 11 may be located in a single computer, or may be located in a plurality of physically different computers. The units implemented by the CPU 11 executing a program may be implemented by a dedicated circuit.

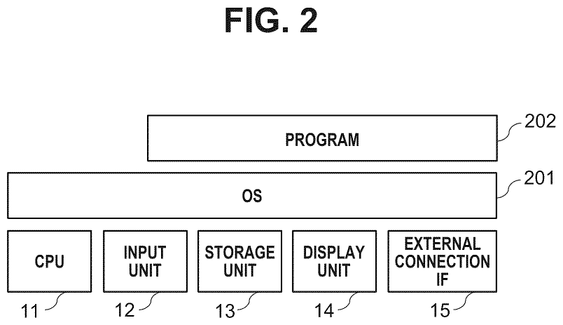

FIG. 2 is a diagram illustrating an example of a system configuration of the information processing apparatus 100. An operating system 201 (hereinafter referred to as the OS 201) is software that serves as the platform for the system.

A program 202 is software that operates on the OS 201.

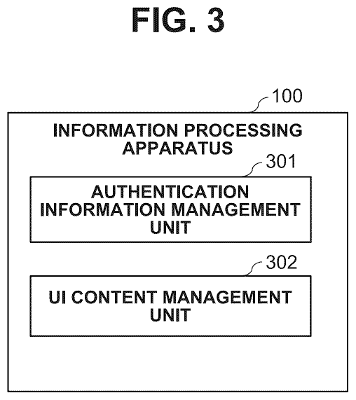

FIG. 3 illustrates a configuration of functions of the information processing apparatus 100. The information processing apparatus 100 includes an authentication information management unit 301 that manages authentication information.

To enter the authentication information, character strings of a user name and a password are typically used, but a four-digit number, gesture on a touch panel, or any other method for entering the authentication information may be used.

The following description presumes that the authentication information is entered using the character strings of the user name and the password.

As an example of an authentication function of the information processing apparatus 100, authentication is successful in a case where preliminarily set authentication information matches authentication information entered by the user, thereby enabling the use of the information processing apparatus 100 or just some of its functions.

The information processing apparatus 100 also includes a user interface (UI) content management unit 302 that displays screens to the user. The term “UI content” refers to original data for a screen to be displayed, and in the present embodiment, the UI content is provided as a HyperText Markup Language (HTML) file. This is not seen to be limiting.

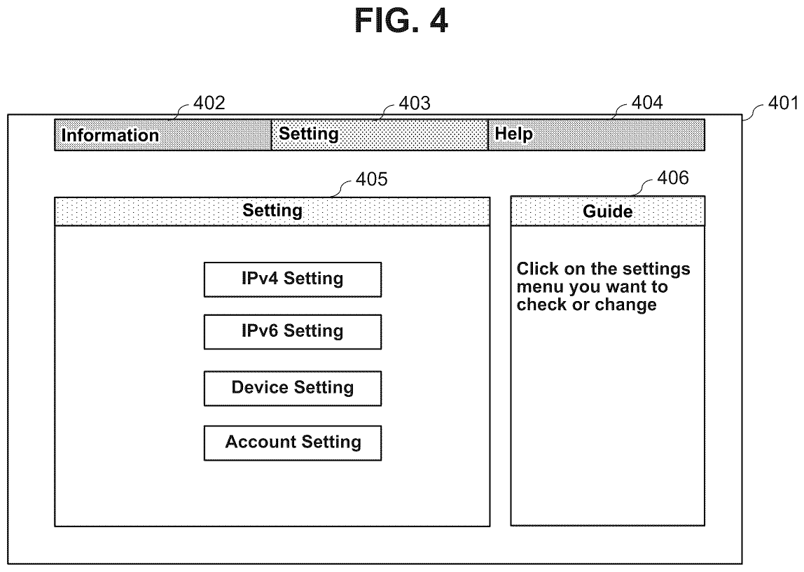

FIG. 4 illustrates an example of a screen (UI screen) displayed by the information processing apparatus 100. The screen may be displayed on a display screen included in the information processing apparatus 100 or may be displayed when the user accesses the information processing apparatus 100 via a web browser from a personal computer (PC) or a smartphone.

A frame 401 is a frame of the entire display screen. Menus 402, 403, and 404 are operation menus of the information processing apparatus 100. FIG. 4 illustrates a state where the menu 403 is selected, and details of the menu 403 are displayed in a Setting region 405 in a lower part of the screen. Operating instructions and hints are displayed in a Guide region 406.

The Guide region 406 is constantly displayed together with the Setting region 405 in which options for an operation performed by the user and/or entry fields are displayed, which enable the user to easily recognize the Guide region 406.

If various settings of the information processing apparatus 100 can be configured by any user, it may result in potential information leakage or other security risks. Thus, authentication is required prior to performing any configuration operations.

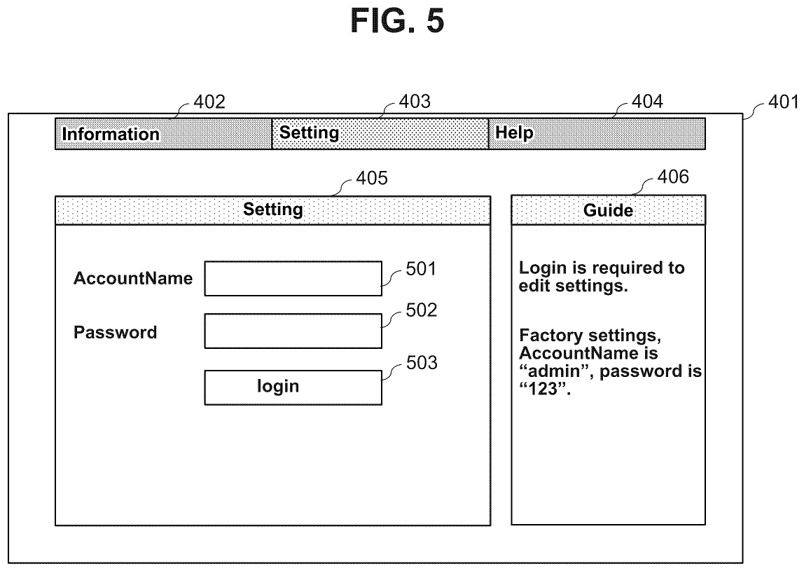

FIG. 5 illustrates an example of an authentication screen displayed by the information processing apparatus 100. This screen is displayed when the user selects the menu 403 or an item that requires authentication within the Setting region 405.

In the Setting region 405, the information processing apparatus 100 displays an entry field 501 in which the account/user name used for authentication information is entered, an entry field 502 in which the password is entered, and a login button 503 to execute authentication.

The information processing apparatus 100 is typically configured with default authentication information at the time the information processing apparatus is shipped from the manufacturer. The default authentication information is typically described in the product manual or similar documentation. This default authentication information represents the initial settings (initial state), and is applied (set) at the time of factory shipment or device reset.

Some users may try and contact a customer support center of the manufacturer of the information processing apparatus for the default authentication information without referring to the manual, resulting in an increased burden on the manufacturer. To prevent such burden, some products constantly display default authentication information in the Guide region 406.

For example, as illustrated in FIG. 5, a default user name and a default password are constantly displayed as “admin” and “123”, respectively, in the Guide region 406.

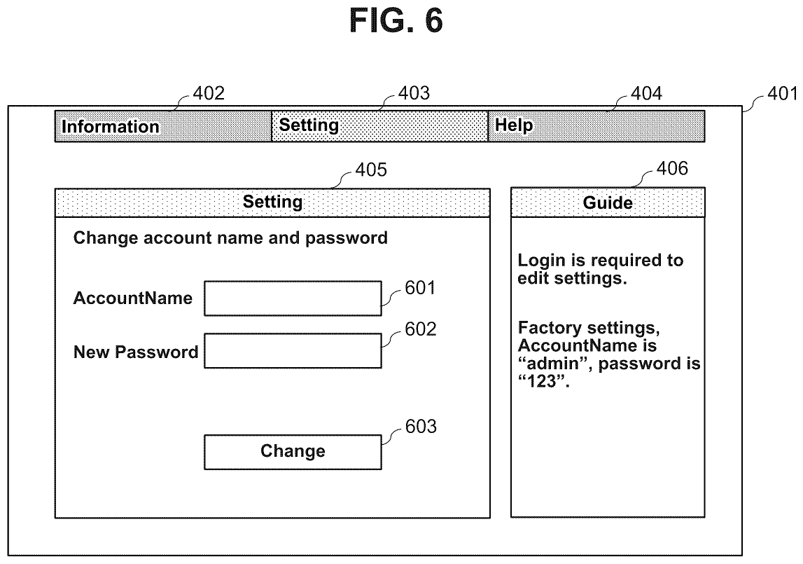

Since the default authentication information poses a security risk, users can change the authentication information. FIG. 6 illustrates a typical screen used to change the authentication information. In FIG. 6, a new user name is entered in an entry field 601, a new password is entered in an entry field 602, and a change button 603 is pressed, thus executing the change.

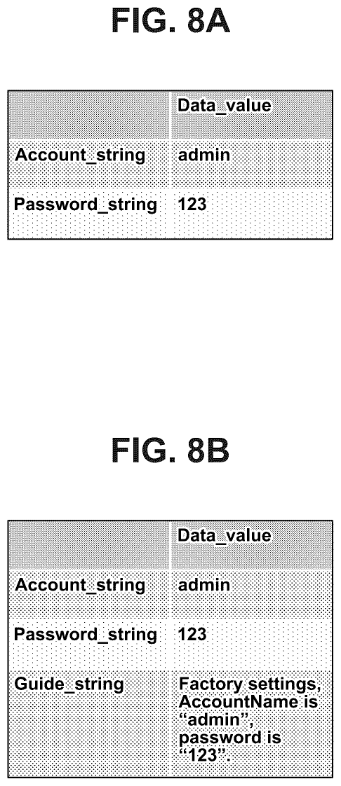

Changed data is stored in a database. FIG. 8A illustrates an example of data stored in the database.

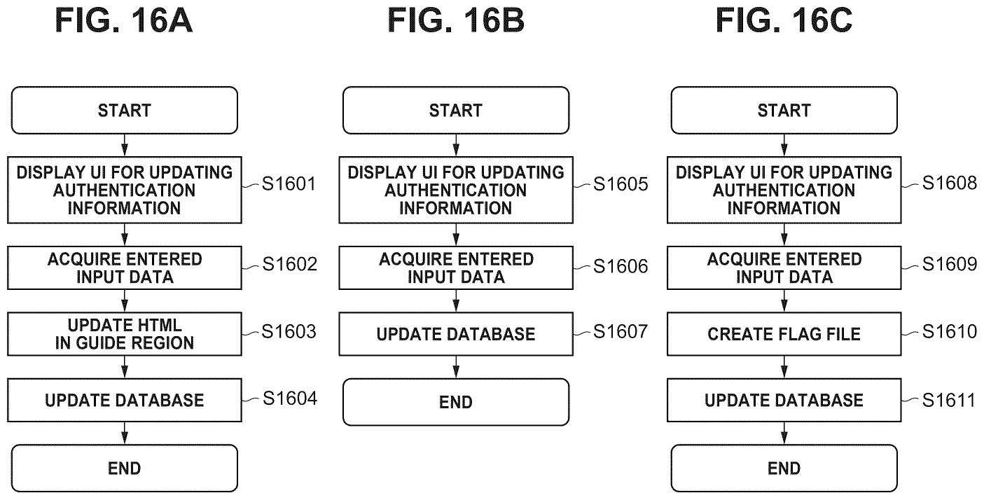

The current description provided so far has been directed to examples of screens displayed by the information processing apparatus 100. Next, the process executed by the information processing apparatus 100 to update the authentication information will be described with reference to FIG. 16A.

The process in the flowchart in FIG. 16A starts when the user performs an operation of updating the authentication information.

Initially, in step S1601, the information processing apparatus 100 displays the screen to update the authentication information in FIG. 6. In step S1602, the information processing apparatus 100 acquires input data entered on the screen. In step S1603, the information processing apparatus 100 updates the HTML for “Guide”, that is, the HTML for the Guide region 406.

An example of a method in step S1603 is to delete character strings including those of the default authentication information. In step S1604, the information processing apparatus 100 updates the database storing the authentication information. The foregoing describes processing in which the information processing apparatus 100 updates the authentication information.

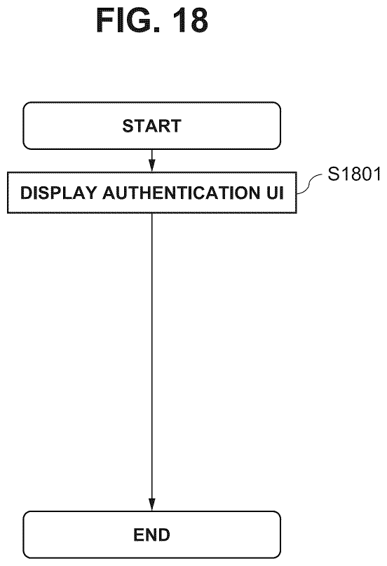

A description will now be provided of the processing in which the information processing apparatus 100 displays an authentication screen with reference to FIG. 18. The processing in the flowchart in FIG. 18 starts when the user performs any operation that requires user authentication. In step S1801, when displaying the authentication screen in FIG. 5, the information processing apparatus 100 displays the UI content defined by the HTML acquired from the UI content management unit 302. The HTML required for the authentication screen in FIG. 5 includes that for the Setting region 405 and the Guide region 406.

When the authentication information remains the default authentication information, the HTML for the Guide region 406 includes the description of the default authentication information. When the authentication information that is not the default authentication information is set, the HTML does not include the description of the default authentication information. Hence, the default authentication information is displayed in “Guide” only when required.

As described above, the present embodiment provides a process in which the information processing apparatus 100 displays the authentication information in “Guide” only when the authentication information is the default authentication information.

### Second Embodiment

The first embodiment provided a description of the method of changing HTML data itself to be displayed in the Guide region 406 in FIG. 5 in response to updating of the authentication information. Depending on the configuration of the information processing apparatus 100, a disk region that stores the HTML data is may be a read-only region where HTML data cannot be changed.

A second embodiment is directed to a method of changing content to be displayed in the Guide region 406 in FIG. 5 without changing HTML data. In the second embodiment, since HTML data cannot be updated, the HTML stored in the information processing apparatus 100 always contains the default authentication information.

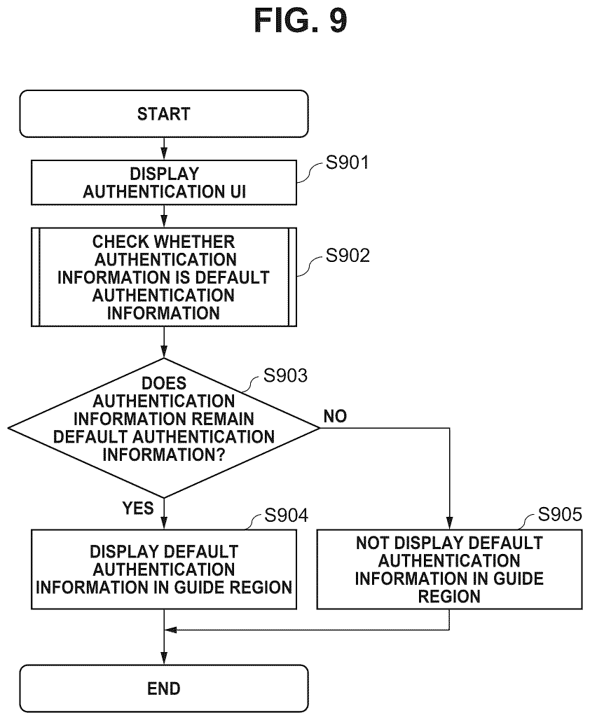

The processing in which the information processing apparatus 100 according to the present embodiment displays an authentication screen is described with reference to FIG. 9. The processing in the flowchart in FIG. 9 starts when the user performs any operation that requires authentication. In step S901, when displaying the authentication screen in FIG. 5, the information processing apparatus 100 displays HTML acquired from the UI content management unit 302. The HTML required for the authentication screen in FIG. 5 includes that for the Setting region 405 and the Guide region 406.

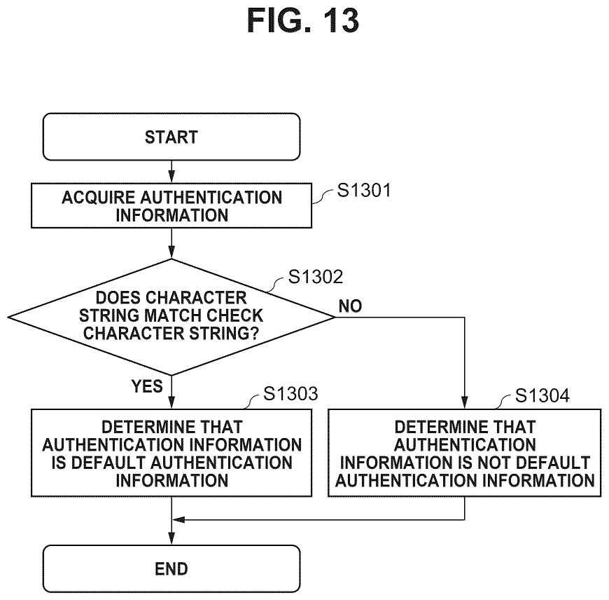

In the present embodiment, the HTML for the Guide region 406 includes character strings of the default authentication information. In step S902, the information processing apparatus 100 checks whether the set authentication information is the default authentication information. The operation of step S902 will be discussed in more detail below with respect to FIG. 13.

In step S903, the information processing apparatus 100, based on the authentication information in step S902, determines whether the authentication information remains unchanged from the default. If the authentication information remains unchanged from the default (YES in step S903), the processing proceeds to step S904. In step S904, the information processing apparatus 100 displays the default authentication information in the Guide region 406.

If the authentication information has been changed from the default (NO in step S903), the processing proceeds to step S905. In step S905, the information processing apparatus 100 does not display the default authentication information in the Guide region 406. In step S905, the information processing apparatus 100 does not directly display the UI content defined by the HTML for the Guide region 406, but instead deletes the HTML tags including default character strings before displaying the UI content. The information processing apparatus 100 performs a modification to add a hint for the authentication information to a predetermined part within the HTML and then responds.

The above-described processing enables the information processing apparatus 100 to display information relating to the default authentication information in “Guide” only when the authentication information remains in its default state.

The HTML stored in the information processing apparatus 100 may be configured such that it does not contain the default authentication information at any time. In this case, the information processing apparatus 100 may add the character strings of the default authentication information in step S904.

The detailed operation in step S902 will now be described with reference to FIG. 13. FIG. 13 is a flowchart of processing in which the information processing apparatus 100 checks whether an authentication setting is a default authentication setting.

Initially, in step S1301, the information processing apparatus 100 uses the authentication information management unit 301 to acquire the set authentication information from the database. In step S1302, the information processing apparatus 100 checks whether the character string of the set user name and that of the set password match check character strings. The check character strings can be easily retained within the firmware of the information processing apparatus 100.

In a case where the character string of the set user name and that of the set password match the corresponding check character strings (YES in step S1302), the processing proceeds to step S1303. In step S1303, the information processing apparatus 100 determines that the authentication information is the default authentication information. In a case where the character string of the set user name and that of the set password do not match the corresponding check character strings (NO in step S1302), the processing proceeds to step S1304. In step S1304, the information processing apparatus 100 determines that the authentication information is not the default authentication information.

The process of updating the authentication information according to the second embodiment will now be described with reference to FIG. 16B. The processing in the flowchart in FIG. 16B starts when the user performs an operation of updating the authentication information.

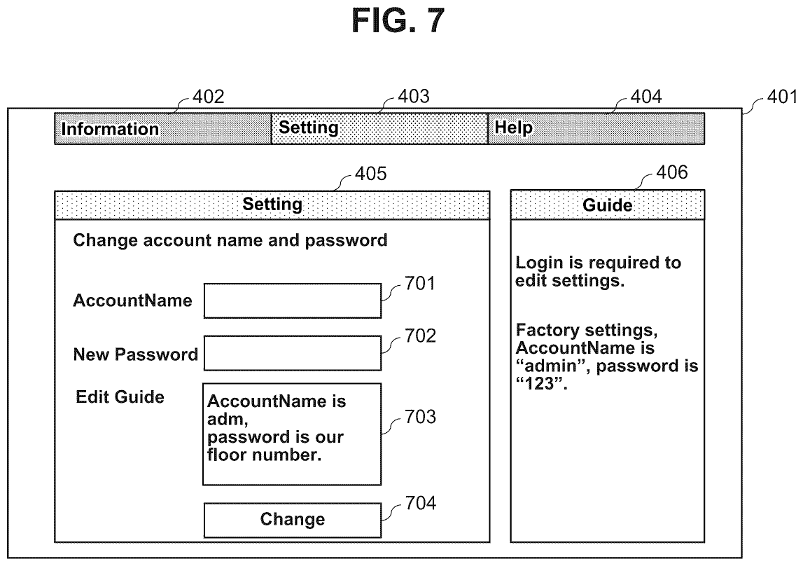

Initially, in step S1605, the information processing apparatus 100 displays the screen for updating the authentication information in FIG. 7. In step S1606, the information processing apparatus 100 acquires input data entered on the screen. In step S1607, the information processing apparatus 100 updates the database that stores the authentication information.

As described above, the present embodiment provides a method that is executed by the information processing apparatus 100 to change the content to be displayed in the Guide region 406 in FIG. 5 without changing the HTML data.

### Third Embodiment

In the second embodiment, the information processing apparatus 100 compares the character strings of the authentication information stored in the database with the check character strings. It is typical, however, for the database to be empty at the time of factory shipment. In such cases, the default authentication information is applied.

A method for omitting the comparison using check character strings will now be described in a third embodiment.

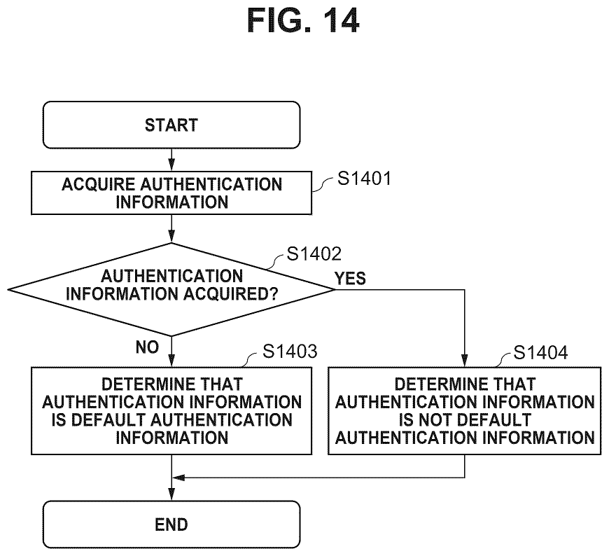

The operation of step S902 according to the third embodiment will be described with reference to FIG. 14.

FIG. 14 is a flowchart illustrating a process in which the information processing apparatus 100 checks whether an authentication setting is in the default state.

Initially, in step S1401, the information processing apparatus 100 acquires the authentication information as in step S1301. In step S1402, the information processing apparatus 100 determines whether the authentication information has been acquired from the database. If the information processing apparatus 100 determines that the authentication information cannot be acquired (NO in step S1402), which means a state where the user has not changed the authentication information, the processing proceeds to step S1403. In step S1403, the information processing apparatus 100 determines that the authentication information is the default authentication information. If the information processing apparatus 100 has succeeded in acquiring the authentication information (YES in step S1402), the processing proceeds to step S1404. In step S1404, the information processing apparatus 100 determines that the authentication information is not the default authentication information.

As described above, the present embodiment provides a method of omitting the comparison using check character strings when the information processing apparatus 100 checks whether the set authentication information is the default authentication information.

### Fourth Embodiment

In the second embodiment, the information processing apparatus 100 compares the character strings stored in the database with the check character strings in step S902. It is also possible to determine, without using the check character strings, whether the set authentication information is the default authentication information by creating a flag file when the user updates the authentication information A method of using the flag file will be described in a fourth embodiment.

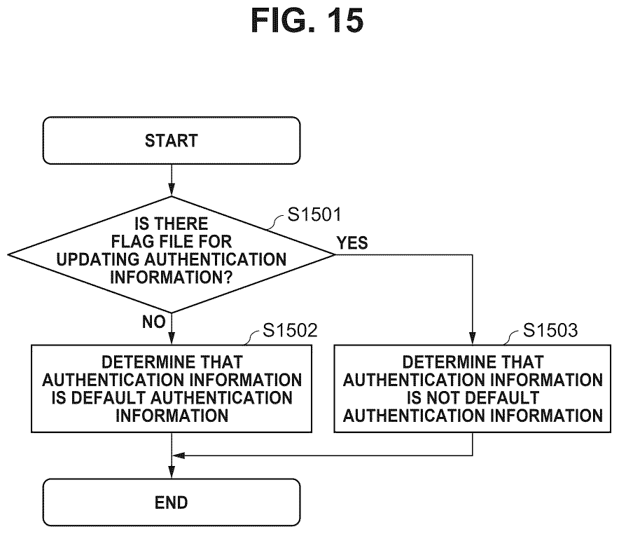

Details of the operation in step S902 according to the fourth embodiment will now be described with reference to FIG. 15. FIG. 15 is a flowchart illustrating a process in which the information processing apparatus 100 checks whether the authentication setting is the default authentication setting.

Initially, in step S1501, the information processing apparatus 100 checks whether a flag file exists. If no flag file is found (NO in step S1501), this indicates that the user has not changed the authentication information, and the processing proceeds to step S1502. In step S1502, the information processing apparatus 100 determines that the authentication information is the default authentication information.

If a flag file is found (YES in step S1501), the processing proceeds to step S1503. In step 1503, the information processing apparatus 100 determines that the authentication information is not the default authentication information.

The process of updating the authentication information according to the present embodiment is described with reference to FIG. 16C. The processing in the flowchart in FIG. 16C starts when the user performs an operation of updating the authentication information. Initially, in step S1608, the information processing apparatus 100 displays the screen to update the authentication information in FIG. 7.

In step S1609, the information processing apparatus 100 acquires the input data entered on the screen. In step S1610, the information processing apparatus 100 creates a flag file. In step S1607, the information processing apparatus 100 updates the database that stores the authentication information.

As described above, the present embodiment provides a method that is executed by the information processing apparatus 100 to refer to a flag file when checking whether the set authentication information is the default authentication information.

### Fifth Embodiment

The first to fourth embodiments provide a method that is executed by the information processing apparatus 100 to display the default authentication information in the Guide region 406 when the authentication information set in the information processing apparatus 100 is the default authentication information.

Changing the default authentication information enables the information processing apparatus 100 to block unauthorized connection attempts from, for example, viruses or bots using the default authentication information. For users prioritizing convenience, there is a need to display the authentication information in the Guide region 406 in case they forget the authentication information, even after changing the authentication information to prevent access by viruses or bots.

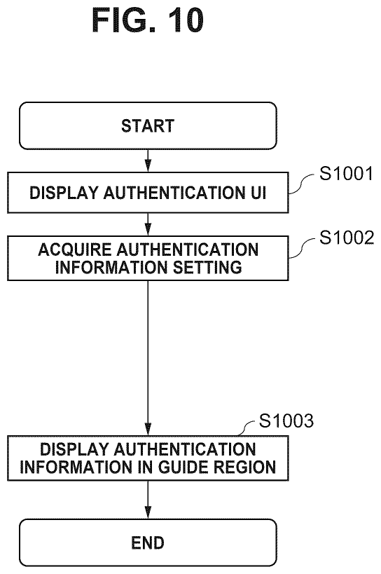

A process in which the information processing apparatus 100 displays an authentication screen will be described in a fifth embodiment with reference to FIG. 10. The processing in the flowchart in FIG. 10 starts when the user performs an operation that requires authentication.

In step S1001, when displaying the authentication screen in FIG. 5, the information processing apparatus 100 displays the UI content defined by the HTML acquired from the UI content management unit 302. In step S1002, the information processing apparatus 100 acquires the set authentication information.

In step S1003, the information processing apparatus 100 inserts a character string of the authentication information in a part where the id attribute of a <div> tag is “loginfo” corresponding to the Guide region 406.

The processing in which the information processing apparatus 100 changes the authentication information may be similar to that described above with respect to FIG. 16B.

The above-described processing enables the information processing apparatus 100 to constantly display the authentication information in the “Guide” region 406 in case the user forgets the authentication information.

### Sixth Embodiment

In the fifth embodiment, the authentication information is displayed as-is in the Guide region 406. Security can be enhanced by displaying the authentication information in a format that provides a hint recognizable only to the user(s) who know it, rather than displaying the authentication information as-is. A method in which the Guide region 406 is also edited when the authentication information is changed will now be described in a sixth embodiment.

The processing in which the information processing apparatus 100 changes the authentication information is similar to that described above with respect to FIG. 16B.

FIG. 7 illustrates an example of a screen for changing the authentication information, which is displayed in the present embodiment. In addition to an entry field 701 in which the user name is entered and an entry field 702 in which a new password is entered, a region 703 for editing the content to be displayed in the Guide region 406 is also displayed.

In the Guide region 406, some users may enter new passwords directly, while other users may enter hints that only those users can recognize. Pressing a button 704 executes the change. The change is stored in the database as illustrated in FIG. 8B.

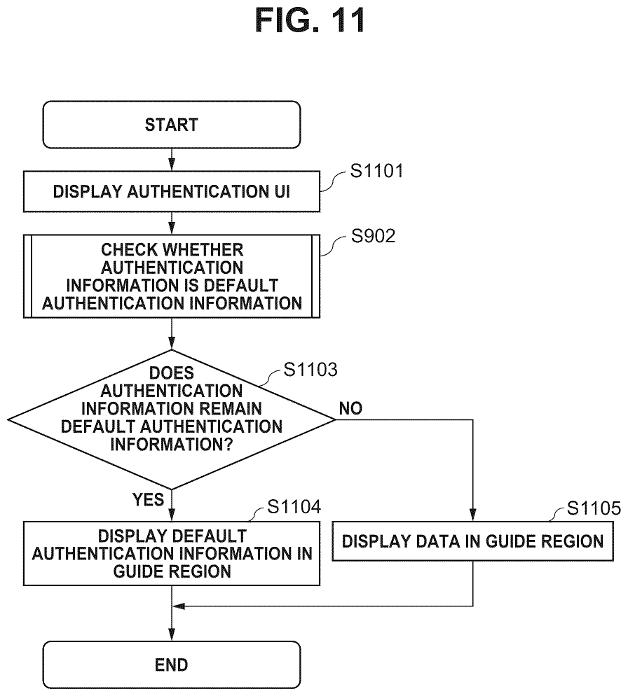

The processing in which the information processing apparatus 100 according to the present embodiment displays an authentication screen will now be described with reference to FIG. 11. The processing in the flowchart in FIG. 11 starts when the user performs any operation that requires authentication.

Initially, in step S1101, the information processing apparatus 100 displays the UI content defined by the HTML acquired from the UI content management unit 302 in displaying the authentication screen in FIG. 5. The HTML required for the authentication screen in FIG. 5 includes that for the Setting region 405 and the Guide region 406. The HTML for the Guide region 406 includes a tag in which a character string of a hint for the authentication information is to be inserted. Specifically, the id attribute of a <div> tag can be set to “loginHint”.

In step S902, as described above, the information processing apparatus 100 checks whether the set authentication information is the default authentication information.

In step S1103, the information processing apparatus 100 checks whether the authentication information remains unchanged from the default authentication information. If the authentication information remains unchanged from the default (YES in step S1103), the processing proceeds to step S1104. In step S1104, the information processing apparatus 100 displays the default authentication information.

Specifically, “Factory settings, AccountName is “admin”, password is “123”.” in FIG. 5 is a character string that describes the default authentication information. The character string that describes the default authentication information is set in a portion where the id attribute of the <div> tag is “loginHint” corresponding to the Guide region 406 in FIG. 5. If the authentication information is not the default authentication information (NO in step S1103), the processing proceeds to step S1105. In step S1105, the information processing apparatus 100 sets data on “Guide_string” in FIG. 8B.

As described above, the present embodiment provides a method of also editing the Guide region 406 when the authentication information is changed.

### Seventh Embodiment

In the sixth embodiment, none of the authentication information is displayed in the Guide region 406 on the screen that requires login as illustrated in FIG. 5 if the user enters nothing in the region 703 in FIG. 7 when changing the authentication information. Some users may expect that even if no entry is made in the region 703 in FIG. 7, the authentication information will be displayed in the Guide region 406 in a manner similar to that when the authentication information is set to the default.

A method of displaying the authentication information in the Guide region 406 when no entry is made in the region 703 in FIG. 7, as in the case where the authentication information is the default authentication information, will now be described in a seventh embodiment.

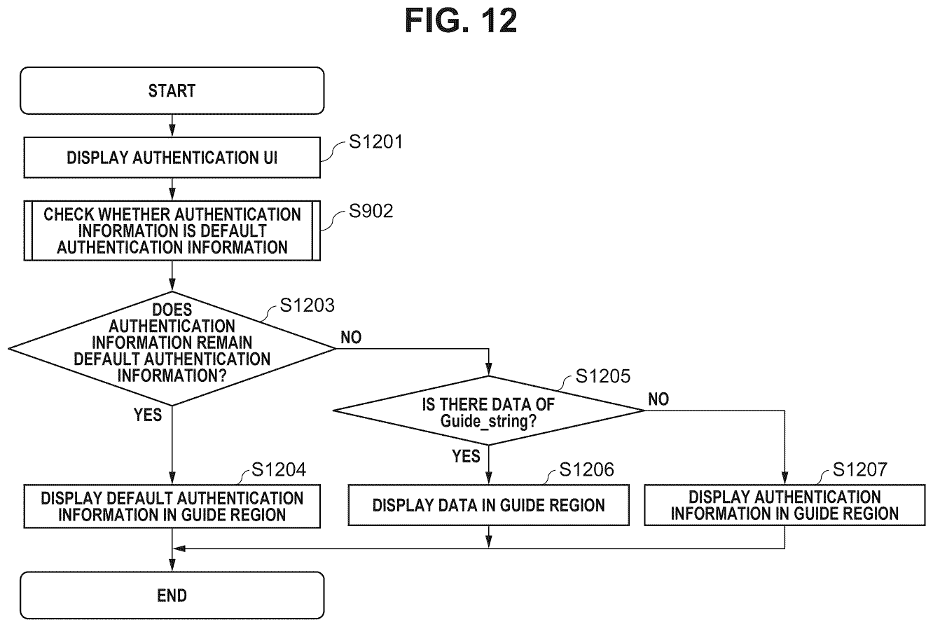

FIG. 12 is a flowchart illustrating a process in which the information processing apparatus 100 according to the seventh embodiment displays an authentication screen. The processing in the flowchart in FIG. 12 starts when the user performs an operation that requires authentication.

Initially, in step S1201, the information processing apparatus 100 displays a UI as in step S1101. In step S902, as described above, the information processing apparatus 100 checks whether the authentication information is the default authentication information. In step S1203, the information processing apparatus 100 checks whether the authentication information remains unchanged from the default. If the authentication information remains unchanged from the default (YES in step S1203), the processing proceeds to step S1204. In step S1204, the information processing apparatus 100 displays the default authentication information as in step S1104.

If the authentication information is not the default authentication information (NO in step S1203), the processing proceeds to step S1205. In step S1205, the information processing apparatus 100 refers to the database in FIG. 8B to check whether there is data of Guide_string. If there is data (YES in step S1205), the processing proceeds to step S1206. In step S1206, the information processing apparatus 100 performs display in Guide region 406 as in step S1105.

If there is no data (NO in step S1205), the processing proceeds to step S1207. In step S1207, the information processing apparatus 100 displays the authentication information in Guide region 406 as in step S1003.

As described above, the present embodiment provides a method executed by the information processing apparatus 100 to switch display in the Guide region 406 depending on the presence/or absence of a Guide setting regarding the authentication information.

### Eighth Embodiment

In the seventh embodiment, if the user enters nothing in the region 703 in FIG. 7 when changing the authentication information, the changed authentication information is displayed on the screen that requires login. While this reduces the user's operational burden, some users may perceive this operation as unintended.

An eighth embodiment provides a method in which, when the user attempts to update the authentication information without entering any input in the region 703, the information processing apparatus 100 prompts the user for confirmation.

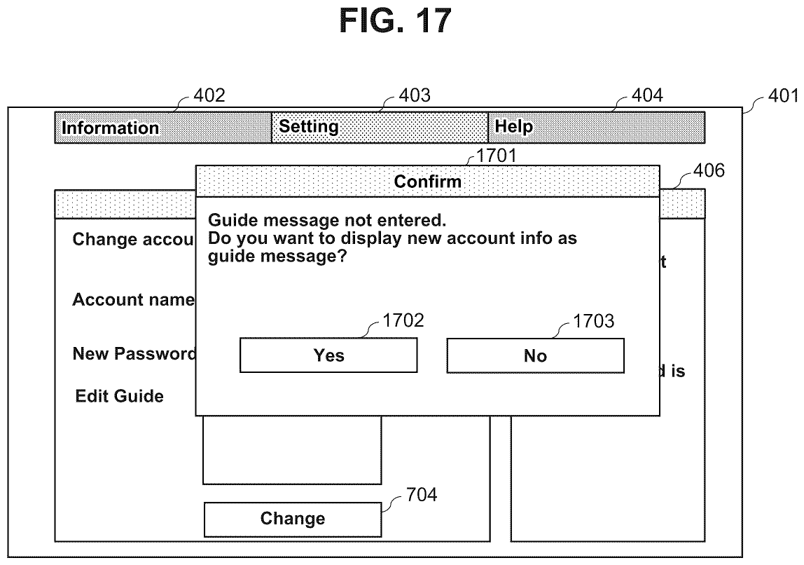

FIG. 17 illustrates an example of a screen that is displayed by the information processing apparatus 100 when the user attempts to update the authentication information without entering any input in the region 703. A dialogue 1701 enables the user to select whether to display new authentication information in the Guide region 406 in a case where no entry is made in the region 703.

If the user agrees by pressing button 1702, an operation similar to that in the seventh embodiment is performed. If the user rejects by pressing button 1703, the dialogue 1701 disappears and the screen returns to the screen for changing the authentication information. The information processing apparatus 100 may store information that the user has rejected the display, and perform an operation similar to that in the sixth embodiment.

The above-described embodiment provides a method for prompting the user for confirmation when the authentication information is to be updated without any input in the region 703.

### Ninth Embodiment

In the seventh embodiment, the region 703 in which the information to be displayed after the change is entered and the Guide region 406 for guiding the user are separated on the screen for changing the authentication information in FIG. 7. It may be difficult for the user to recognize that the information entered in the region 703 is reflected in the Guide region 406.

To address this, a ninth embodiment provides a method in which the display in the Guide region 406 is synchronized with the content being entered in the region 703, such that the display in the Guide region 406 is updated in real time based on the input in the region 703.

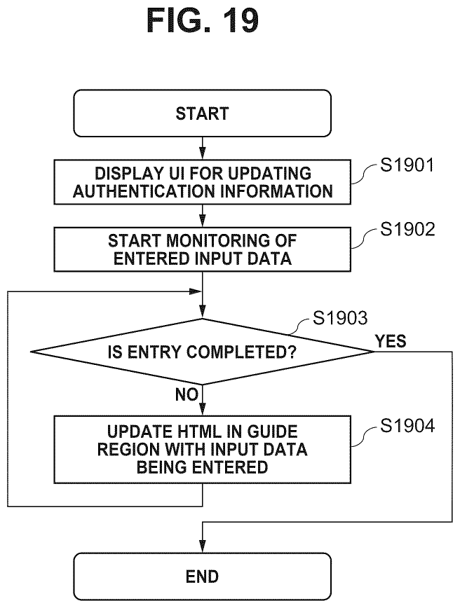

FIG. 19 is a flowchart illustrating a process in which the information processing apparatus 100, when displaying the screen in FIG. 7 and receiving entry in the region 703, reflects the entry in the region 703 as a hint for the authentication information in the screen. The processing in the flowchart in FIG. 19 starts when the user performs an operation of updating the authentication information.

Initially, in step S1901, the information processing apparatus 100 displays the UI illustrated in FIG. 7, which is the screen for updating the authentication information. In step S1902, the information processing apparatus 100 starts monitoring of entry in the region 703. One example of a monitoring method is registering an input event listener for the region 703 using web script language (e.g., JavaScript™).

In step S1903, the information processing apparatus 100 determines whether the user has completed the input. One example of input being considered complete is when the button 704 is pressed. If the input has not been completed (NO in step S1903), the processing proceeds to step S1904. In step S1904, the information processing apparatus 100 overwrites data displayed in the Guide region 406 in FIG. 7 with the input data being entered in the region 703. The overwriting is implemented using, for example, JavaScript™.

As described above, when the region 703 for inputting information to be displayed after change and the Guide region 406 for providing instructions to the user are separated, the information processing apparatus 100 displays the information in a manner that is easily understandable to the user.

### OTHER EMBODIMENTS

While details of the above-described embodiments have been provided, the present disclosure may be implemented in various forms, such as a system, an apparatus, a method, a program, and a recording medium (storage medium).

The present disclosure may be applied to a system including a plurality of devices (e.g., a host computer, an interface device, an imaging apparatus, and a web application) or a single device.

The present disclosure may also be implemented by supplying a computer-readable recording medium (storage medium) that stores control program codes (computer program) of software that implements functions of the above-described embodiments to a system or an apparatus.

A computer (CPU or a micro-processing unit (MPU)) of the system or the device reads the control program code stored in the recording medium and executes the control program code. In this case, the control program code itself read from the recording medium realizes the functions of the above-described embodiments, and the recording medium storing the control program code are included in the scope of the present disclosure.

According to the present disclosure, it is possible to appropriately display a hint for authentication information or the authentication information itself.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-170040, filed Sep. 30, 2024, which is hereby incorporated by reference herein in its entirety.

What is claimed is:

1. An information processing apparatus including an authenticating function using authentication information, the information processing apparatus comprising:
a display;
at least one memory storing a program; and
at least one processor executing the program to:
display, on the display, the authentication information that is currently set.

2. The information processing apparatus according to claim 1, wherein the at least one processor further executes the program to display, on the display, the authentication information only in a case where the authentication information is in an initial state.

3. The information processing apparatus according to claim 1, wherein the at least one processor further executes the program to register information regarding a hint for the authentication information, and
wherein the registered information about the hint for the authentication information is displayed on the display.

4. The information processing apparatus according to claim 3, wherein, in a case where the information about the hint is not registered, the authentication information is displayed on the display.

5. The information processing apparatus according to claim 3, wherein, in a case where an instruction to update the authentication information is provided without entry of the information about the hint, a confirmation regarding whether to display the authentication information after the instruction to update the authentication information is provided is displayed on the display.

6. The information processing apparatus according to claim 3, wherein the at least one processor further executes the program to modify HyperText Markup Language that is data to be displayed on the display, and
wherein the information about the hint for the authentication information is added to a predetermined part of the HyperText Markup Language.

7. The information processing apparatus according to claim 6, wherein the processor further executes the program to manage the authentication information,
wherein a web script included in the HyperText Markup Language acquires the information to manage the authentication information, and
wherein the acquired information is displayed on the display.

8. The information processing apparatus according to claim 3, wherein, based on the registered information regarding the hint, the information about the hint is updated in real time and displayed.

9. A method for controlling an information processing apparatus including an authenticating function using authentication information, the method comprising displaying the authentication information that is currently set.

10. A non-transitory computer-readable storage medium storing a program that causes an information processing apparatus to perform a method, the method comprising displaying the authentication information that is currently set.
